(19) United States
(12) Patent Application Publication
(10) Pub. No.: US 2019/0234439 A1
(43) Pub. Date: Aug. 1, 2019

(54) INTEGRATED ENGAGEMENT PROFILE AND INSTALLATION ASSEMBLY INCLUDING A FIRST LAYER AND AN INSTALLATION TOOL FOR ENGAGEMENT OF THE PROFILE THROUGH AN APERTURE DEFINED IN A FURTHER ATTACHABLE LAYER

(71) Applicant: U.S. Farathane Corporation, Auburn Hills, MI (US)

(72) Inventors: Steve Porter, Auburn Hills, MI (US); Jonathon Dewey, Auburn Hills, MI (US)

(21) Appl. No.: 16/247,809

(22) Filed: Jan. 15, 2019

Related U.S. Application Data
(60) Provisional application No. 62/625,056, filed on Feb. 1, 2018.

(51) Int. Cl. F16B 2/24; F16B 19/10

(52) U.S. Cl. CPC F16B 2/243; F16B 19/1081

(57) ABSTRACT

An invert-able feature in a first layer for securing a second layer. A profile projects from an interior recess defining perimeter of the first layer, the profile including angled sides and a central interconnecting and actuating face. Beams extend from the sides and, upon positioning the second layer, are in communication with an aperture of the second layer. A tool having an actuating profile is applied to an exterior facing sided of the pyramidal profile and is exerted to cause the pyramidal shape to compress together and subsequently invert through a reduced area represented by the recessed interior to travel past an underside of the first layer, with the beams caused to displace to engage the second layer to the first layer.

### CROSS REFERENCE TO RELATED APPLICATIONS

The present application claims priority from U.S. Ser. No. 62/625,056 filed Feb. 1, 2018.

### FIELD OF THE INVENTION

The present invention relates generally to a fastener profile integrated into a first material layer and including a pyramidal-shaped base initially projecting in an underside direction of the first material layer. Upon positioning a second layer with an interior aperture over the fastener profile, a separate tool is employed against the projecting pyramid base for inverting the profile through the first material layer and so that first and second beams associated with angled sides of the pyramidal base seat through the aperture in contact with opposite edge extending sides of the aperture.

### BACKGROUND OF THE INVENTION

The present invention is documented with various types of engagement fasteners for securing together first and second material layers. Examples of these include the attachment clip of Nishikawa U.S. Pat. No. 6,997,662 which, in relevant part, includes a clip body having an abutting part for abutment on a heat shielding plate. The abutting part has a shank hole for passage of a bolt shank. The attachment clip further includes engagement claws projecting inwardly from an inner periphery of the clip body. The engagement claws have respective engagement tips formed to depart from the clip body along an axial direction of the attachment chip and providing a cone-shaped configuration. The engagement claws elastically engage with threads of the shank while urging the heat shielding plate toward an under-panel along the axial direction of the bolt.

Also disclosed is the sheet metal panel fastener of Duffy U.S. Pat. No. 3,675,958 which includes inner and outer arms connected by a resilient, reversely bent bight. Both of the arms have through openings formed therein and are normally disposed in divergent un-tensioned relationship to each other.

The outer arms each include two sections connected by resilient webs having an inverted U-shaped configuration, with the opening in the outer arm at least partially defined by a pair of stud gripping tongues struck upwardly from the adjacent ends of the arm sections substantially between the connecting webs. The fastener is particularly adapted for clamping an apertured member to a support having a stud projecting from the surface thereof, confronting the member and through the aperture in the member by compressing the arms toward a substantially parallel relationship with each other to bring the openings therein into registering alignment and forcing the arms downwardly over the stud. In this manner, the tongues grippingly engage the stud and, upon removal of the compressing force, exert an axial pull on the stud thereby tensioning the apertured member against the support. The fastener also includes means which are easily operable to release the tongues from gripping engagement with the stud for removal of the fastener.

Other references include the fastener of Anscher, US 2004/0253074 which includes an anchor and a central pin. The anchor has a top plate to which a central leg is connected. At the free end of the central leg are two anchor arms that extend up and outward from the free end, forming an arrowhead shape. The anchor arms are flexible and can flex inward as the anchor is placed through a hole in an item to be fastened. Connected to the top surface of the top plate is a push pin. Depressing the push pin breaks the connection areas to create a two-piece anchor from the single part. The push pin comprises a push button and a pin connected to the underside of the push button. The pin consists of a vertical post having a channel therein for accommodating the central leg of the anchor. Pushing the push button downward causes the anchor arms to be pushed outward and to anchor the fastener into the items to be fastened.

### SUMMARY OF THE PRESENT INVENTION

The present invention discloses an invert-able attachment feature incorporated into a first layer of any material for securing through an aperture location defined in a second layer. The feature includes a profile projecting from an interior recess defining perimeter of the first layer, the profile including a substantially pyramidal shape with first and second angled sides and a central most interconnecting and actuating face.

A pair of elongated beams extend from the sides and, upon positioning the second layer, are in communication with the aperture location. A separate tool is provided as part of an installation assembly and exhibits an actuating profile which, upon being applied to an exterior facing sided of the pyramidal shaped profile so that an engaging surface of the tool is in contact with the actuating face, allows an engaging force to be exerted by the tool, causing the pyramidal shape to compress together and subsequently invert through a reduced area represented by the recessed interior and to therefore travel past an underside of the first layer. In this manner, the beams are caused to displace in order to securely engage the second layer to the first layer.

The beams can be displaced inwardly concurrent with inversion of the profile to bridge an edge location of the second layer, thereby straddling an interior perimeter defining edge location of the aperture. The beams can also be displaced outwardly concurrent with inversion of the profile to engage opposite perimeter edges of the defined interior aperture in the second layer.

Additional variants contemplate other multi-sided pyramidal shaped profiles, such including three, four or more sides. The tip profiles of the elongated beams can be similarly redesigned and, if need be, the associated tool can be likewise modified to actuate the beams either inwardly or outwardly in cooperation with the inverting motion of the interconnected sides.

Other aspects include the tool having a substantially pyramidal end profile with angled sides extending from opposite sides of the actuating profile. A recessed slot shape with straight or tapered interior extending sides is configured into the actuating profile and extending sides of the tool for recess seating of the beams prior to and during actuation of exterior projecting sides of the pyramidal profile and to guide the beams so that they invert together in a controlled and concurrent fashion.

The first layer can also include a rigid plasticized material, with the second layer a softer plasticized material. In additional applications, the first layer is provided as a pressure relief valve (PRV) frame, with the second layer being a flap secured to an interior edge of the PRV frame in communication with an interior window thereof against which the flap is seated in a closed position.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of an in-material designed and invert-able profile associated with a first material layer, the profile including a pyramidal shaped base including first and second angled sides projecting from a surrounding surface of the first material layer, in combination with a central actuating surface, a pair of engagement beams projecting from projecting the angled sides;

FIG. 2 is a rotated perspective of FIG. 1 and illustrating a recessed underside of the pyramidal shaped base, an aperture in the main layer coinciding with a perimeter of the base for permitting said pyramidal shaped profile to be inverted through the aperture during actuation thereof;

FIG. 3 is a perspective illustration of an in-material designed and invert-able profile associated with a first material layer and according to a further variant, the profile including first and second angled sides associated with a reverse pyramidal shaped base which is recessed from a surrounding surface of the first material layer, a pair of engagement beams projecting from the inwardly recessed angled sides;

FIG. 4 is a rotated perspective of FIG. 3 and illustrating a rear side of the reverse pyramidal shaped base exhibiting a reverse and projecting profile with first and second angled sides in combination with a central actuating surface;

FIG. 5 is an illustration of the variant of FIG. 1 and illustrating the inversion pyramid attachment feature which is molded requiring no “action” in the tool to form the required geometry;

FIG. 6 is a succeeding illustration to FIG. 5 and showing a second material layer with interior perimeter defined aperture overlaying the first material layer so that a selected one of the engagement beams seats through the aperture in a pre-actuated condition;

FIG. 7 is a further succeeding illustration to FIG. 6 in which an insertion tool is provided in abutting position over the beams prior to inversion actuation of the pyramidal profile;

FIG. 7A is an enlarged and rotated partial perspective of a tip portion of the insertion tool of FIG. 7 and better illustrating the recessed profile of the tool engagement surfaces including a slot configuration in the engaging end face which seats the beams;

FIG. 8 is a subsequent and post inverted illustration showing the inward abutting engagement of opposing inside end surfaces of the beams concurrent with inversion of the pyramidal angled base surfaces through the first material layer;

FIG. 9 is an illustration of the variant of FIG. 3 and illustrating the reverse inverted pyramid attachment feature is molded requiring no “action” in the tool to form the required geometry;

FIG. 10 is a succeeding illustration to FIG. 9 and showing a second material layer with interior perimeter defined aperture overlaying the first material layer and so that the pair of engagement beams seat through the aperture in a pre-actuated condition;

FIG. 11 is a further succeeding illustration to FIG. 10 in which an insertion tool is provided in alignment with a central planar engagement surface portion of the reverse inverted pyramidal profile in a pre-actuated condition;

FIG. 12 is a subsequent and post inverted illustration showing the outward abutting engagement of opposing inside end surfaces of the beams concurrent with inversion of the pyramidal angled base surfaces through the first material layer;

FIGS. 13-15 provide a series of perspective illustrations of a pressure relief valve housing associated with one application of the present invention and in which a rigid tray portion defines the first material layer with a plurality of integrated inversion profiles, one or more softer flaps defining the second material layer with edge proximate apertures for being engaged by the pivoting beams associated with the inversion profile.

### DETAILED DESCRIPTION OF THE PREFERRED EMBODIMENTS

With reference to the attached illustrations, the present invention discloses a fastener profile and related tool assembly which is integrated into a first material layer, such as including but not limited to a rigid material such as a pressure relieve valve housing associated with a vehicle ventilation application. The fastener profile, as will be further described, includes variants of a pyramidal shaped base, such configured in extending fashion from an interior aperture perimeter of the first material layer and initially projecting in a given direction from a base line surface of the first material layer.

Upon positioning an interior aperture configured within a second layer, such as which can include a soft flap in communication with a window formed in the rigid PRV or other first material, a separate tool is employed in actuating fashion against the projecting pyramid surfaces for inverting the profile across the interior aperture and through the first material layer and so that first and second beams associated with angled sides of the pyramidal base are displaced in order to seat through or against the side edges of the aperture.

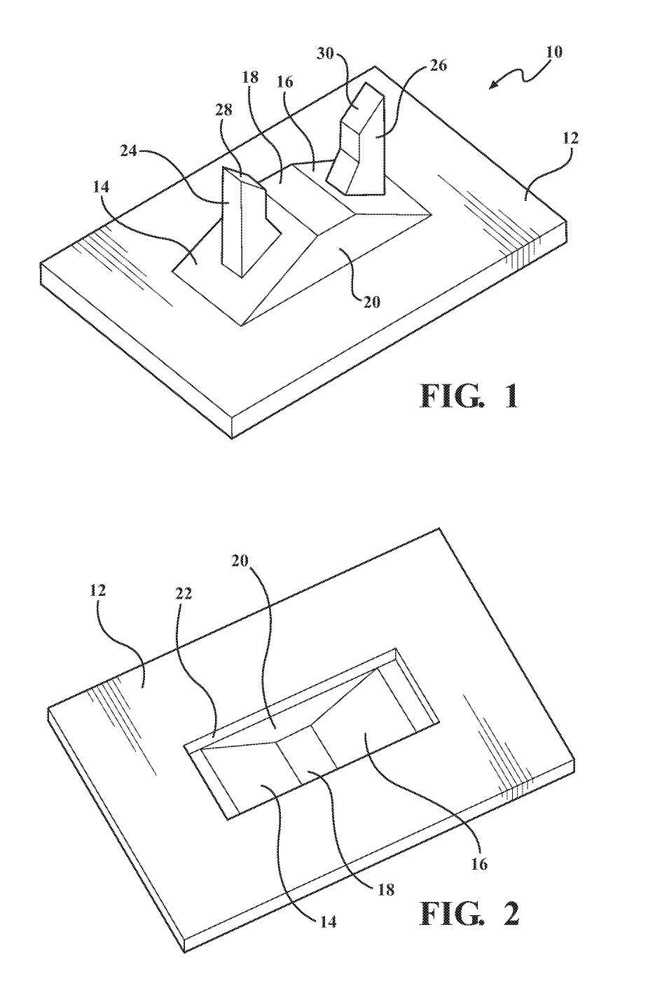

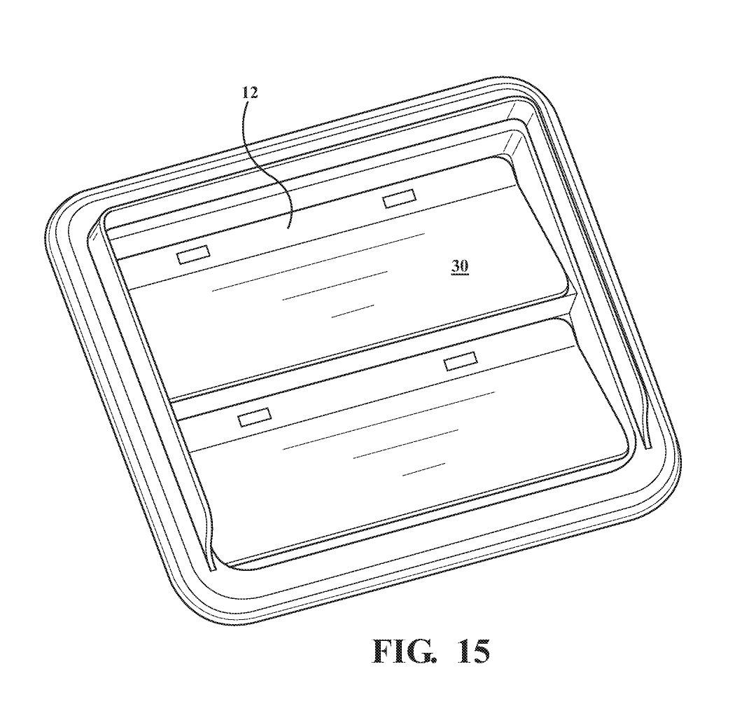

Referring first to FIG. 1, a perspective illustration is depicted at 10 of an in-material designed and invert-able profile associated with a first material layer 12. While depicted as a planar piece having limited dimensions, the base or first material 12 depicted in FIGS. 1-2 is understood as being integrated into any desired component or part not limited according to any of shape, configuration or size and including such as the PRV housings of FIGS. 13-15. The first material 12 can also, without limitation, can again include any rigid, typically plasticized material not limited to such as a rigid tray defining a pressure relief housing, examples of which are depicted in FIGS. 13-15.

The profile 10 depicted includes a pyramidal shaped base with first 14 and second 16 angled sides projecting from a surrounding surface of the first material layer 12 and which, in combination with a width extending and interconnecting central actuating surface 18 and interconnecting side skirts (one of which is shown at 20), extends upwardly from the surrounding base surface (again at 12) associated with the rigid first material layer. In a non-limited embodiment, the pyramidal profile can be molded from thermoplastic material attached to a previously incised or cutout interior perimeter (defined by rim edge 22 in FIG. 2) by a suitable closed mold configuration. Without limitation, the modified pyramidal configuration of the profile 10 can alternatively be constructed in other ways, such not limited to utilizing the original material of the first layer 12 (such as a polypropylene or other suitable plastic), and which can be shaped/distressed into the three dimensional profile configuration as shown.

FIG. 2 is a rotated underside perspective of FIG. 1 and illustrates a recessed underside of the pyramidal shaped base (with angled sides 14/16 and central actuating surface 18), an aperture in the main layer (see again inside perimeter rectangular profile 22) which is surrounded by pyramidal molded features, and such permitting the pyramidal shaped profile to be progressively compressed and inverted through the aperture during actuation thereof in the manner which will be subsequently described. As previously described, the material for the pyramidal profile is typically molded to the inner perimeter cutout edges of the first layer, however can alternatively originate as a portion of the unitary material surface of the first layer which can be reconfigured by a suitable die or press into the modified pyramidal shape, such as further to include durable/living hinge at the adjoining edge locations between the pyramidal defining panels and the base edge of the first material layer.

As again shown in FIG. 1, a pair of engagement beams 24 and 26 project from the angled sides 14 and 16. The construction of the beams is such that each includes an inwardly opposing facing support surface (see at 28 and 30 for beams 24 and 26) located proximate the upper most and inner angled and opposing locations of the beams and which, upon the pyramidal shaped engagement feature being actuated in a descending and over center hinge reversing fashion through the aperture inner perimeter rim 22, causes the beams to pivot both angularly and inwardly so that the supports surfaces 28/30 define a pincer abutting motion (see in the fashion shown in FIG. 8) so that they are in inwardly pyramidal contact relative to one another.

In this fashion, and upon the sides 14/16 and ends 20 being caused to be compressed/collapsed through the fixed open aperture defined by the interior perimeter edge 22, the beams 24/26 are actuated inwardly towards one another as part of the reverse displacing motion of the sides and which, upon re-expanding in an over-center hinged fashion through the aperture rim 22 (again FIG. 8) causes the actuated beams to grasp or retain an aperture location (see inner perimeter rim at 28 of a second softer material layer 30), such as further including a valve functioning flap in the instance of the PRV housing structure of FIGS. 13-15, and which can be mounted so that it seats through an interior window defined in the first material rigid tray (again at 12 in FIGS. 13-15). As further shown, the configuration of the second, typically softer flap layer 30 associated with the variant of FIGS. 1, 2 and 5-8 (only a portion of which being represented to enhance depiction of the beam engagement aspect) is such that the beams 24/26 are pivoted together to bridge an edge perimeter of the flap 30 defined between an outer edge 32 (again FIG. 8) and an inwardly and parallel spaced edge defining a portion of the inside perimeter rim 28 of the flap.

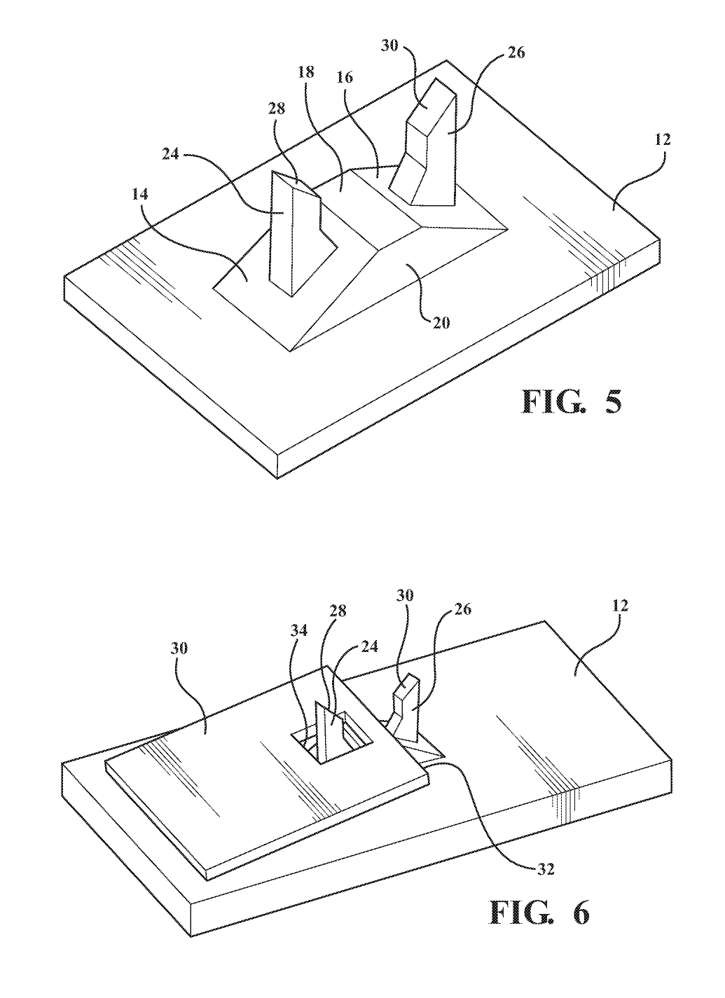

FIG. 5 is a substantial repeat illustration of the variant of FIG. 1 and illustrating the inversion pyramid attachment feature which is molded requiring no “action” in the tool to form the required geometry. FIG. 6 is a succeeding illustration to FIG. 5 and showing the second material layer 30 (this again depicting a minor portion of such as a soft PRV housing flap as depicted in 15), the second/softer material 30 having the interior perimeter defined aperture 34 overlaying the first material layer and so that a selected one 24 of the engagement beams seats through the aperture in a pre-actuated condition (the outer beam 26 as shown residing outside of the outer edge 32 of the second material 30).

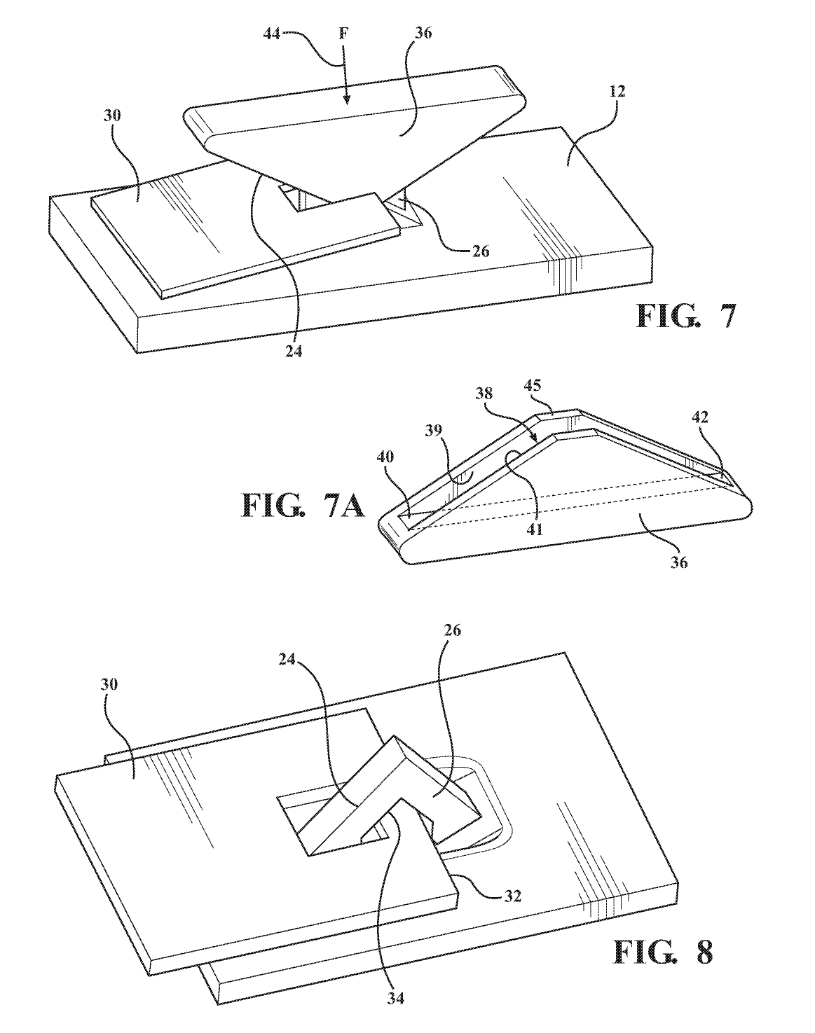

FIG. 7 is a further succeeding illustration to FIG. 6 in which an insertion tool, such as depicted by a triangular three dimensional shaped actuating body 36, is shown and is arrayed in an abutting and pre-actuating position over the beams 24 and 26 prior to inversion actuation of the pyramidal profile. FIG. 7A is an enlarged and rotated partial perspective of the tip of the triangular shaped body 36 of the insertion tool of FIG. 7 and better illustrating the recessed interior profile of the tool engagement surfaces, this including an elongated slot configuration leading to a recessed interior (see generally at 38), the recessed interior further defined by spaced apart side surfaces 39 and 41 and interconnected end surfaces 40 and 42.

An interior base surface 43 is sufficiently dimensioned relative to a flattened central most projecting surface portion 45 of the tool 36 aligning with the opposing and flattened actuating face 18 of the pyramidal profile in order to permit angular displacement of the beams 24/26 during the inward collapsing and over-center motion of the pyramidal profile between FIGS. 7-8. The tool 36 is positioned as shown in FIG. 7, so that the beams 24/26 are seated within the cavity. Following a downward actuating force (see directional arrow 44 in FIG. 7) exerted upon pyramidal profile (such further assisted by a flattened central most projecting surface portion 45 of the tool 36 aligning with the opposing and flattened actuating face 18 of the pyramidal profile), the modified pyramidal profile is caused to invert through the aperture 20 defined in the first material layer 12, in the manner previously described and as depicted in FIG. 8.

In the inverted/engaged position of FIG. 8, the opposing inside pincer surfaces 28 and 30 of the beams 24 and 26 are caused to concurrently displace toward one another (again resulting from the reverse hinged and inverted pivoting of the angled side support and pyramidal base surfaces 14 and 16 through the first material layer in the over-center hinged and concurrent compressive/re-expansive fashion in order to define a secure engagement profile as shown in FIG. 8 which is further assisted by the material properties of the pyramidal profile). In this fashion, the beams 24/26 are displaced inwardly concurrent with inversion of the profile to bridge the edge location of the inner defined perimeter 34 of the second layer, thereby straddling the interior perimeter defining edge location as described.

As a result, the pincering of the beams 24/26 resulting from inversion of the pyramidal base feature provides sufficient holding force for retaining the second material layer 30 in secured fashion upon the first layer 12 and without the need for separate clips, fasteners or the like. It is further understood that the material construction of the first layer 12 with pyramidal fastener is sufficiently rigid to retain the beams 24/26 in their pincered arrangement against one another, with a reverse actuating opening of the same being accomplished by the subsequent and re-application of the force (action) applying tool 36 so that the central end surfaces 45 are positioned against a reverse projecting surface of the actuating face 18 (also depicted in the original and pre-displaced recessed position of FIG. 2).

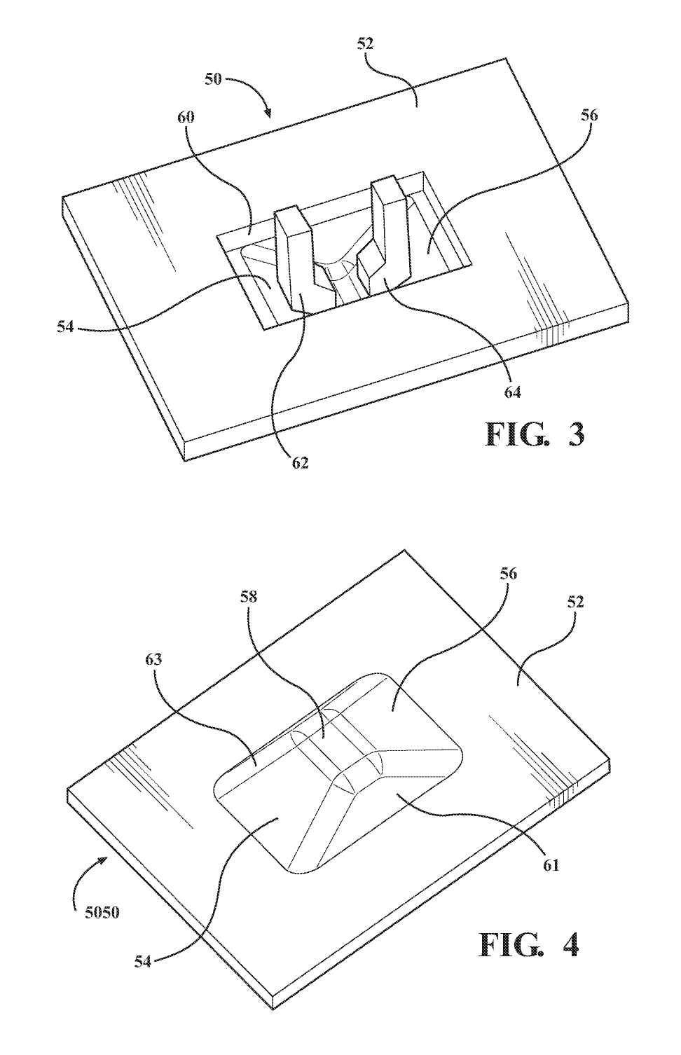

FIG. 3 is a perspective illustration of an in-material designed and invert-able fastener engagement profile, generally at 50, according to a further embodiment and associated with a first material layer 52 and according to a further variant. Similar to the initial variant 10 of FIGS. 1-2 & 5-8, the profile 50 of FIGS. 3-4 and 9-12 includes first 54 and second 56 angled sides associated with a reverse pyramidal (inverted) shaped base which is recessed from the surrounding surface 52 of the first material layer (compare to at 12 in FIG. 1). The underside or rear side projecting surface of the pyramidal feature (see FIG. 4) further includes a central actuating face 58 which is similar to that depicted in the reverse profile arrangement of FIG. 1.

A rectangular aperture is defined by an inner perimeter rim 60 which is configured in the material layer 52 which, similar to that shown at 22 in FIG. 2, defines an interior perimeter surrounded by the connecting perimeter of the pyramidal feature also including side skirt portions 61 and 63 which, in combination with the angled sides 54/56 and the central actuating face 58, define a feature which can be actuated on an exterior projecting side by a separate tool in order to invert through the aperture in order to invert and, in this instance, outwardly pivot a pair of engagement beams 62 and 64 projecting from the inwardly recessed angled sides. FIG. 4 is a rotated perspective of FIG. 3 and illustrating a rear side of the reverse pyramidal shaped base exhibiting the reverse and (outwardly) projecting profile with the first and second angled sides 54/56 in combination with the central actuating surface 58 and side edge skirt portions 61/63.

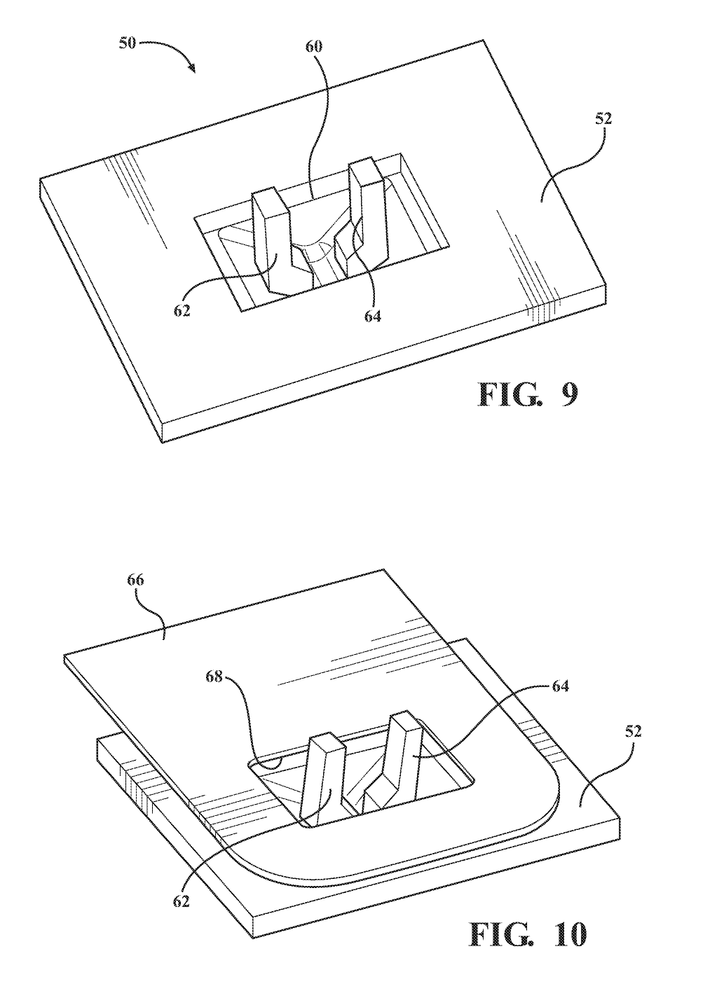

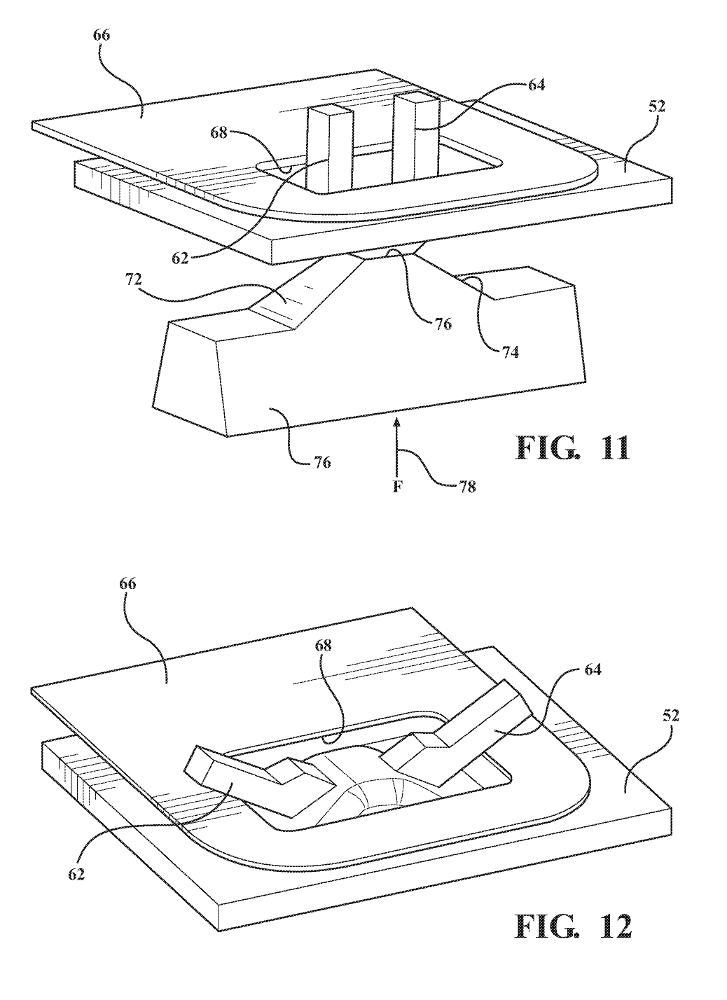

Proceeding to FIG. 9, an illustration is again shown of the variant of FIG. 3 and illustrating the reverse inverted pyramid attachment feature which is molded into the body of the first material 52 in order to require a no “action” feature of the related tool in order to form the required geometry. FIG. 10 is a succeeding illustration to FIG. 9 and showing a second material layer 66 with interior perimeter defined aperture (see inner perimeter surface 68) overlaying the first material layer 52 and so that the pair of engagement beams 62/64 seat through the aperture in a pre-actuated condition.

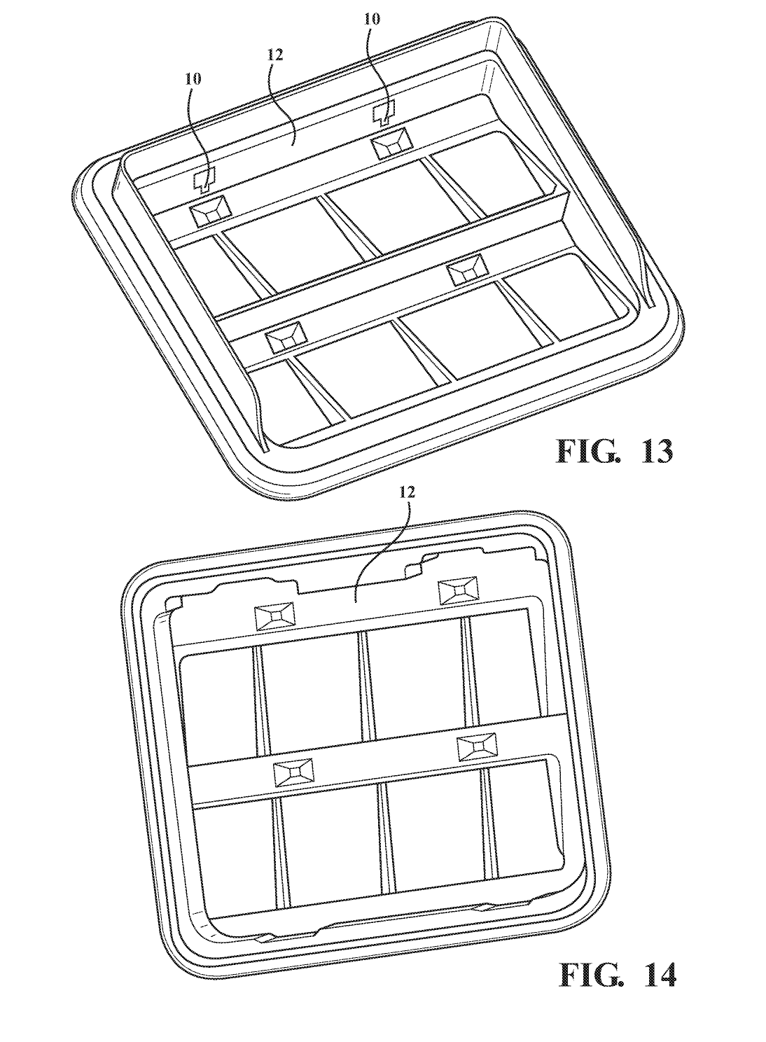

FIG. 11 is a further succeeding illustration to FIG. 10 in which an insertion tool 70 (of varying design in comparison to that shown at 36 in FIGS. 7-7A) is provided and includes a similar pyramidal profile to that shown in the tool 36, such with angled side surfaces 72/74 converging in a flattened uppermost surface 76. Upon aligning the end most surface 76 of the tool 70 with the underside and upward projecting actuating face 58 against the in-molded pyramidal feature, the tool 70 is force actuated (arrow 78) to reverse collapse the pyramidal feature through the interior perimeter 60 formed in the material 52 (such as in a similar fashion as associated with the modified pyramidal profile of FIG. 1) and, in so doing, to cause the beams 62/64 projecting from the angled faces 54/56 to be pivoted outwardly as depicted in FIG. 12 (as opposed to inwardly in the alternate example of FIG. 8 in the first embodiment) such that the beams 62/64 extend beyond the perimeter edges of the window 68 in order to grip the aperture edges and prevent the second (e.g. flap) material layer 66 from becoming disengaged from the first (more rigid) material layer 52.

Referencing again FIGS. 13-15, provided are a series of perspective illustrations of a pressure relief valve housing associated with one application of the present invention and in which the rigid tray portion (again depicted at 12 but also contemplating use of the profile associated with the material layer 52 of the secondary embodiment of FIG. 3) defines the first material layer with a plurality of integrated inversion profiles (again either including as depicted at 10 in FIG. 1 or at 50 in FIG. 3). One or more softer flaps (again shown at 30 but including also as depicted at 66 in FIGS. 10-12) defines a second material layer with edge proximate apertures for being engaged by the pivoting beams associated with the inversion profile and in order to hold the second layer softer flaps in place in edge secured fashion.

It is envisioned that the in-molded and inverse pivoting pyramidal attachment features can replace (or supplement) other attachment options including welds, adhesives or the like. The shape and configuration of the inversion profile and pivot beams can also adapted to different mounting environments for securing a surface layer (via an interior aperture formed thereon) against the base material which integrates the inversion feature into its material construction.

Additional variants contemplate other multi-sided pyramidal shaped profiles, which can include without limitation such as three, four or more interconnected sides extending at an upwardly projecting angle relative to the interconnecting multi-sided perimeter edge. The tip profiles of the elongated beams can be similarly redesigned and, if need be, the associated tool can be likewise modified to actuate the beams either inwardly or outwardly in cooperation with the inverting motion of the interconnected sides.

Further, and while applicable to any variant of engagement profile, any envisioned multi-sided variant (such as defined as three or greater interconnected sides) can in particular be utilized with an outwardly displacing array of elongated beams such as shown in the engaged position in FIG. 12. It is also envisioned that, beyond the pair of elongated beams shown with the illustrated variants having first and second inverting sides, other variants can include any of multiple beams or no beams associated with a selected side and in order to define other varied engagement profiles beyond that shown. Yet additional variants contemplate other variants of plural extending and protruding/angled sides which are not necessarily interconnected along opposing angled edges (and such as is shown by sides 14, 16 and 20 in FIG. 1).

It is also envisioned in other variants that the central location, such as shown at 18 in FIG. 1, can be removed with the angled perimeter defining sides 16, 18, et seq., joining centrally in any of a tip or edge. In such a variant, the tip of the engagement tool can be redesigned from that shown at 36 or 76 in order to contact and actuate the angled or pyramidal profile in inverting fashion through the interior open perimeter of the aperture defined in the second layer.

Having described my invention, other and additional preferred embodiments will become apparent to those skilled in the art to which it pertains, and without deviating from the scope of the appended claims:

I claim:

1. An assembly including a first layer with an invert-able attachment feature for securing a second layer through an aperture in the second layer, said assembly comprising:
a profile adapted to project from an interior defined perimeter of the first layer;
said profile including a plurality of angled sides extending from said perimeter and being joined together at a central location;
elongated beams extending from one or more of said angled sides, said beams being pre-positioned in proximity to an open interior of the aperture in the second layer; and
a tool having an actuating tip applied against the central location, a subsequent engaging force exerted by said tool in a direction toward the aperture causing said angled sides to invert through said recessed interior of the first layer and past a positioned underside of the first layer, the beams being caused to angularly displace during inverted motion in order to contact edges of the second layer to secure the second layer to the first layer.

2. The assembly of claim 1, further comprising said beams being displaced inwardly concurrent with inversion of said profile to bridge an interior perimeter edge defining location of the second layer straddling said aperture.

3. The assembly of claim 1, further comprising said beams being displaced outwardly concurrent with inversion of said profile to engage opposite perimeter edges of the aperture in the second layer.

4. The assembly of claim 1, further comprising said tool having a substantially pyramidal end profile with angled sides extending from opposite sides of said actuating profile.

5. The assembly of claim 4, further comprising a recessed slot shape configured into said actuating profile and extending sides of said tool for recess seating said beams prior to and during actuation of exterior projecting sides of said pyramidal profile.

6. The assembly of claim 1, the first layer further comprising a rigid plasticized material.

7. The assembly of claim 1, the second layer further comprising a softer plasticized material.

8. The assembly of claim 1, the first layer further comprising a pressure relief valve (PRV) frame, the second layer a flap secured to an interior edge of the PRV frame in communication with an interior window thereof against which the flap is seated in a closed position.

9. An assembly including an invert-able attachment feature incorporated into a first layer for securing through an aperture location of a second layer, comprising:
a profile projecting from an interior recess defining perimeter of the first layer;
said profile including a substantially pyramidal shape with first and second angled sides and a central most interconnecting and actuating face;
a pair of elongated beams extending from said sides and, upon positioning the second layer, being in communication with the aperture location in the second layer; and
a separate tool having a pyramidal end profile with angled sides extending from opposite sides of an actuating profile, a recessed slot shape configured into said actuating profile and extending sides of said tool for recess seating said beams prior to and during actuation of exterior projecting sides of said pyramidal profile and, upon being applied to an exterior facing sided of said pyramidal shaped profile so that an engaging surface of said tool is in contact with said actuating face, an engaging force exerted upon said tool causing said pyramidal shape to invert through said recessed interior and past an underside of the first layer, the beams being caused to displace in order to secure the second layer to the first layer.

10. The assembly of claim 9, further comprising said beams being displaced inwardly concurrent with inversion of said profile to bridge an interior perimeter edge defining location of the second layer straddling said aperture.

11. The assembly of claim 9, further comprising said beams being displaced outwardly concurrent with inversion of said profile to engage opposite perimeter edges of the aperture in the second layer.

12. The assembly of claim 9, said first layer further comprising a rigid plasticized material.

13. The assembly of claim 9, said second layer further comprising a softer plasticized material.

14. The assembly of claim 9, said first layer further comprising a pressure relief valve (PRV) frame, said second layer a flap secured to an interior edge of the PRV frame in communication with an interior window thereof against which the flap is seated in a closed position.

15. An invert-able attachment feature incorporated into a first layer for securing through an aperture location of a second layer, comprising:
a profile projecting from an interior recess defining perimeter of the first layer;
said profile including a substantially pyramidal shape with first and second angled sides and a central most interconnecting and actuating face;
a pair of elongated beams extending from said sides and, upon positioning the second layer, being in communication with the aperture location defined in the second layer; and
upon a downward engaging force being applied to said pyramidal shaped profile, said first and second angled sides being forcibly inverted through said recessed interior and past an underside of the first layer, said extending beams being caused to concurrently displace in order to secure edges of the aperture in the second layer to the first layer.

16. The attachment feature of claim 15, further comprising a tool exhibiting an actuating profile for engaging said pyramidal shape profile.

17. The attachment feature of claim 15, further comprising said beams being displaced inwardly concurrent with inversion of said profile to bridge an interior perimeter edge defining location of the second layer straddling said aperture.

18. The attachment feature of claim 15, further comprising said beams being displaced outwardly concurrent with inversion of said profile to engage opposite perimeter edges of the aperture in the second layer.

19. The attachment feature of claim 16, further comprising said tool having a substantially pyramidal end profile with angled sides extending from opposite sides of said actuating profile.

20. The attachment feature of claim 19, further comprising a recessed slot shape configured into said actuating profile and extending sides of said tool for recess seating said beams prior to and during actuation of exterior projecting sides of said pyramidal profile.
